(19) United States
(12) Patent Application Publication
(10) Pub. No.: US 2008/0043116 A1
(43) Pub. Date: Feb. 21, 2008

(54) Electronic Device and a Method in Electronic Device for Forming Image Information, and a Corresponding Program Product

(76) Inventors: Jouni Lappi, Nokia (FI); Jaska Kangasvieri, Tampere (FI)

Correspondence Address: HARRINGTON & SMITH, PC, 4 RESEARCH DRIVE, SHELTON, CT, 06484-6212, US

(21) Appl. No.: 11/632,232

(22) PCT Filed: Jun. 28, 2005
(86) PCT No.: PCT/FI05/50240

§ 371 Date: Jan. 10, 2007

(30) Foreign Application Priority Data
Aug. 2, 2004 (FI) 20045286

(51) Int. Cl. H04N 5/228

(52) U.S. Cl. 348/222.1; 348/E05.031

(57) ABSTRACT

The invention relates to an electronic device, which includes camera means, including at least one camera element (CAM1) for forming image data (DATA1) from an imaging subject, a first lens arrangement (F1) according to a set focal length, arranged in connection with the camera means, and means for processing the image data (DATA1) into image information (IMAGE), the processing including, for example, zooming of the imaging subject. The said camera means additionally include at least a second camera element (CAM2) equipped with a second lens arrangement (F2), the focal length of which differs from the focal length of the said first lens arrangement (F1) in an established manner and from the sets of image data (DATA1, DATA2) formed by the first and second camera elements (CAM1, CAM2) is arranged to be processed by using the data-processing means the image information (IMAGE) with the desired zooming of the imaging subject. In addition, the invention also relates to a method and program product.

The present invention relates to an electronic device, which includes
camera means, including at least one camera element for forming image data from an imaging subject,
a first lens arrangement according to a set focal length, arranged in connection with the camera means, and
means for processing the image data into image information, the processing including, for example, zooming of the imaging subject.

In addition, the invention also relates to a method and a corresponding program product.

A single camera element is known from several present electronic devices, one individual example being camera phones. The set of lenses associated with it is arranged to be essentially fixed, for example, without any kind of zoom possibility.

Digital zooming is presently in use in several known types of electronic devices. It has, however, certain known defects. These defects relate, for example, to the image definition. When digital zooming is performed on an image, the pixel network of the image data becomes less dense. As a result, interpolation of the image data, for example, in which additional pixels are developed in the data, becomes necessary. This leads to an inaccuracy in the zoomed image.

Present electronic devices equipped with camera means, such as precisely mobile stations, are known to be characterized by being quite thin. It is challenging to arrange an axial movement functionality in the set of lenses in a device of such a thin nature. It is practically impossible, without increasing the thickness of the device. In addition, adding an optically implemented zooming functionality to such devices generally increases their mechanical complexity. In addition, the sensors and their sets of lenses can also easily distort the image in various ways.

The present invention is intended to create a new type of electronic device equipped with camera means, as well as a method for forming image information in the electronic device, by means of which it will be possible to produce substantially more precise image information than then using traditional single-sensor implementations. The characteristic features of the electronic device according to the invention are stated in the accompanying claim 1 while the characteristic features of the method applied in it are stated in claim 8. In addition, the invention also relates to a program product, the characteristic features of which are stated in the accompanying claim 16.

The electronic device according to the invention includes camera means, including at least one camera element for forming image data from an imaging subject, a first lens arrangement according to a set focal length, arranged in connection with the camera means, and means for processing the image data into image information, the processing including, for example, zooming of the imaging subject. The camera means of the device additionally include at least a second camera element equipped with a second lens arrangement, the focal length of which differs from the focal length of the said first lens arrangement in an established manner. From the sets of image data formed by the first and second camera elements of the device is arranged to be processed by using the data-processing means the image information with the desired zooming of the imaging subject.

Further, in the method according to the invention camera means are used to perform imaging in order to form image data of the imaging subject, the camera means including at least one camera element equipped with a first lens arrangement with a set focal length and the formed image data is processed, for example, in order to zoom the imaging subject. In the method imaging is performed in addition using at least a second camera element, the focal length of the lens arrangement in connection with which differs in a set manner from the focal length of the said first lens arrangement and image information with the desired zooming is processed from the sets of image data formed by using the first and second camera elements.

Further, the program product according to the invention, for processing image data, to which the invention thus also relates, includes a storage medium and program code written on the storage medium for processing image data formed by using at least one camera element and in which the image data is arranged to be processed to image information, the processing including of, for example, the zooming of the imaging subject. The program code includes a first code means configured to combine in a set manner two sets of image data with each other, which sets of image data are formed by using two camera elements with different focal lengths.

In addition, the invention also relates to the use of a camera element in the device according to the invention, or in connection with some sub-stage of the method according to the invention.

Using the data-processing means of the device according to the invention, image data can be combined in several different ways. According to a first embodiment, image regions, formed from the image data, can be attached to each other to form image information with a desired zooming. According to a second embodiment, the pixel information of the sets of image data can be adapted at least partly to each other by calculation, to form image information with the desired zooming.

In a surprising manner, the invention permits the creation of a zoom functionality in electronic devices. Owing to the invention, a zoom functionality can be created, even entirely without movement operations acting on the lens arrangements.

Use of the invention achieves significant advantages over the prior art. Owing to the invention, a zoom functionality can also be arranged in small electronic devices equipped with camera means, in which size factors, for example, have previously prevented implementation of a zoom functionality. By means of the arrangement according to the invention, the definition or quality of the zoomed, i.e. cropped and enlarged image information are practically no poorer than those of image information produced using optical zooming, for example. The definition achieved owing to the invention is, however, at least in part of the image area, better than in digital zooming according to the prior art.

Further, use of the image-data-processing operations applied in the invention achieves smooth and seamless joining of image data. This is of particular significance in cases in which the camera means of the device differ in quality. Also, correction of various kind of distortions are possible.

Other features characteristic of the electronic device, method, and program product according to the invention will become apparent from the accompanying Claims, while additional advantages achieved are itemized in the description portion.

In the following, the invention, which is not restricted to the embodiment disclosed in the following, is examined in greater detail with reference to the accompanying figures, in which

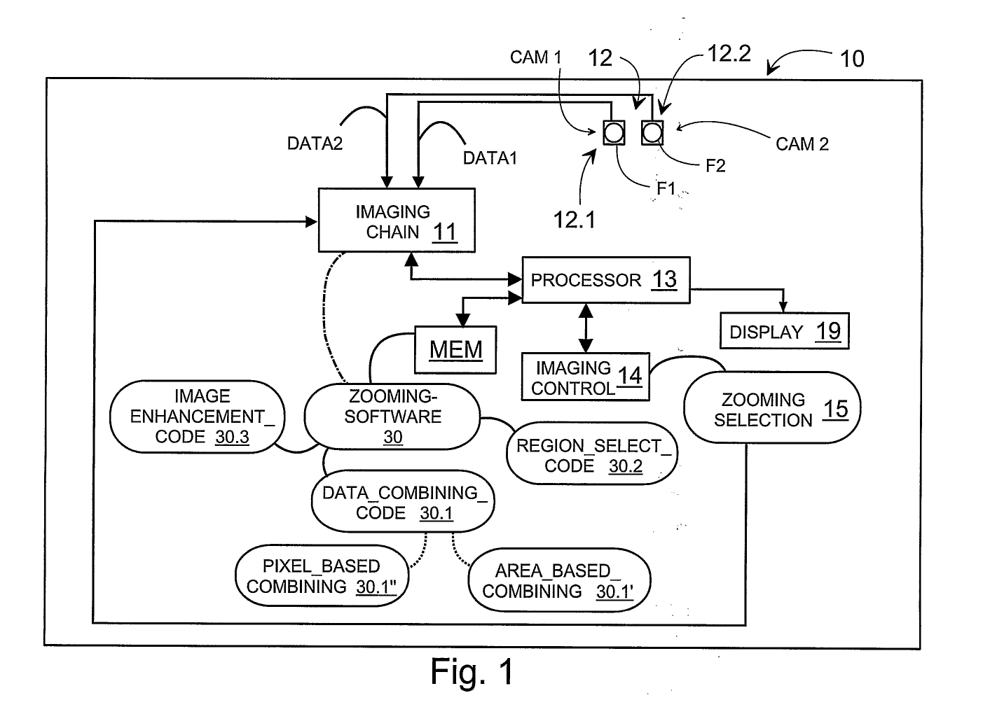

FIG. 1 shows an example of the electronic device according to the invention,

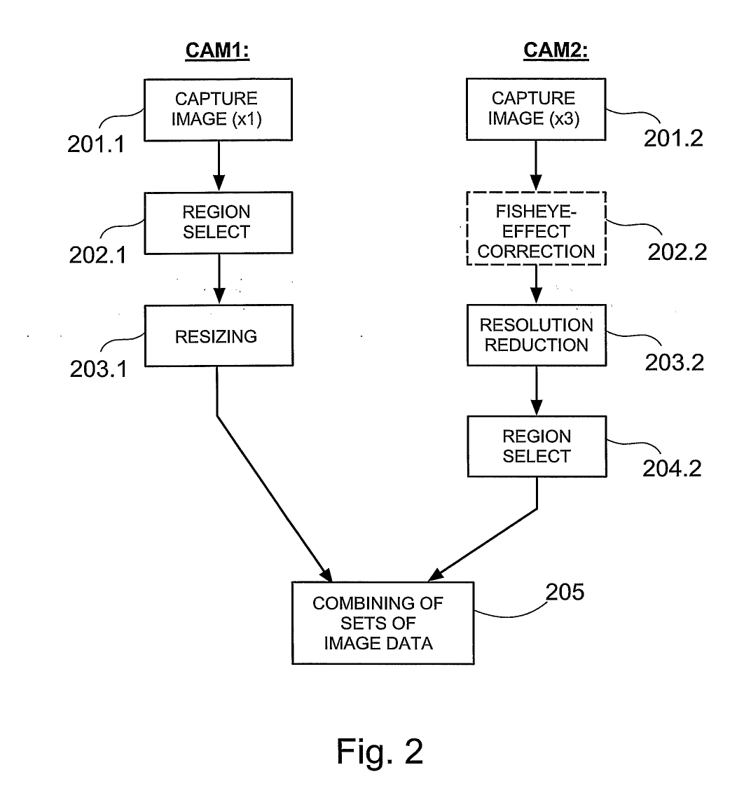

FIG. 2 shows a rough flow diagram of an example of the method according to the invention, and

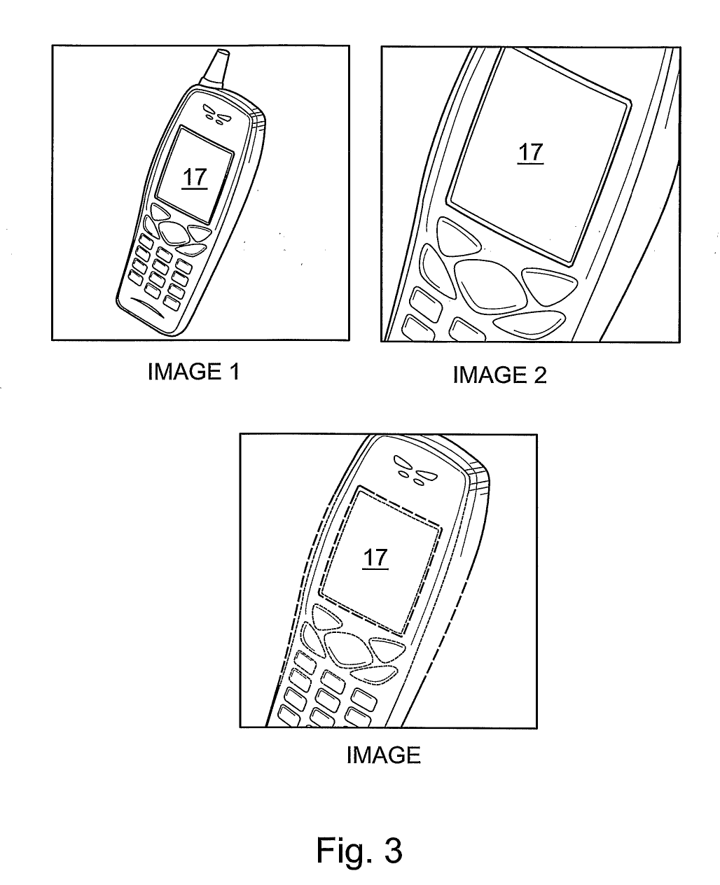

FIG. 3 shows an example of an application of the combination of image data, in a manner according to the invention.

Nowadays, many electronic devices 10 include camera means 12. Besides digital cameras, examples of such devices include mobile stations, PDA (Personal Digital Assistant) devices, and similar ‘smart communicators’. In this connection, the concept ‘electronic device’ can be understood very widely. For example, it can be a device, which is equipped, or which can be equipped with a digital-imaging capability. In the following, the invention is described in connection with a mobile station 10, by way of example.

FIG. 1 shows a rough schematic example of the functionalities in a device 10, in as much as they relate to the invention. The device 10 can include the functional components, which are, as such known, shown in FIG. 1. Of these, mention can be made of the camera means 12 and the data-processing means 11 in connection with them, as being the essential components in terms of the implementation of the device 10 according to the invention, by means of which the program product 30 is implemented on either the HW or SW level, in order to process the image data DATA1, DATA2 formed by the camera means 12.

In the case according to the invention, the common term ‘camera means’ 12 refers to at least two camera elements CAM1, CAM2, and in general to all such technology relating to camera modules in general when performing digital imaging. The camera means 12 can be permanently connected to the device 10, or they can also be detachably attached to the device 10.

In the solution according to the invention, the camera means 12 include at least two camera elements CAM1, CAM2. The cameras CAM1, CAM2 are aimed, for example, in mainly the same imaging direction, relative to the device 10. Both camera elements CAM1, CAM2 can then include their own independent image sensors 12.1, 12.2, which are physically separate from each other. On the other hand, an arrangement may also be possible, in which both camera units CAM1, CAM2 are essentially in the same modular camera component, while still forming, however, essentially two camera elements CAM1, CAM2.

The camera elements CAM1, CAM2, or more particularly the image sensors 12.1, 12.2 belonging to them, can be identical and arranged in the device 10 on the same side of it, facing mainly a common exposure direction. The sensors 12.1, 12.2 can, in addition, be on the same horizontal level and thus adjacent to each other, when the device 10 is held in its basic position (which is, for example, vertical in the case of a mobile station 10).

Further, the device 10 can also include a display 19, which is either of a type that is known, or of one that is still being developed, on which information can be visualized to the user of the device 10. However, the display 19 is no way mandatory, in terms of the invention. A display 19 in the device 10 will, however, achieve, for example, the advantage of being able, prior to imaging, to examine the imaging subject 17 on the display 19 that acts as a viewfinder. As an example of an arrangement without a display, reference can be made to surveillance cameras, to which the invention can also be applied. In addition, the device 10 also includes a processor functionality 13, which includes functionalities for controlling the various operations 14 of the device 10.

The camera means 12 and the data-processing means arranged in connection with them as a data-transfer interface, for example, an image-processing chain 11, can be formed of components (CCD, CMOS) that are, as such, known, and of program modules. These can be used to capture and process still and possibly also moving image data DATA1, DATA2, and to further form from them the desired kind of image information IMAGE1, IMAGE2, IMAGE. The processing of the image data DATA1, DATA2 into the desired kind of image information IMAGE can include not only known processing functions, but also according to the invention, for example, the cropping of the imaging subject 17 as desired and the enlargement of the cropped image area to the desired image size. These operations can be referred to by the collective title zooming.

Zooming can be performed using program 30. The program 30, or the code forming it can be written on a storage medium MEM in the device 10, for example, on an updatable, non-volatile semiconductor memory, or, on the other hand, it can also be burned directly in a circuit 11 as an HW implementation. The code consists of a group of commands to be performed in a set sequence, by means of which data processing according to a selected processing algorithm is achieved. In this case, data processing can be mainly understood to be the combination of sets of data DATA1, DATA2 in a set manner, in order to form image information IMAGE from them, as will be explained in later in greater detail.

The image information IMAGE can be examined, for example, using the possible display 19 of the device 10. The image data can also be stored in a selected storage format in the memory medium of the device 10, or it can also be sent to another device, for example, over a data-transfer network, if the device 10 is equipped with communications properties. The imaging chain 11 performing the processing of the image data DATA1, DATA2 is used to process, in a set manner, the image data DATA1, DATA2 formed of the imaging subject 17 from the imaging direction by the camera means 12, according to the currently selected imaging mode, or imaging parameter settings. In order to perform the settings, the device 10 includes selection/setting means 15.

In the device 10 according to the invention, the camera units CAM1, CAM2 operate mainly simultaneously when performing imaging. According to a first embodiment, this means an imaging moment that is triggered at essentially the same moment in time. According to a second embodiment, even a small difference in the time of the imaging moment can be permitted, provided that this is permitted, for example, by the subject being imaged. In that case, for example, such a powerful data-processing capability is not required in the imaging chain 11 of the device 10, compared, for example, to a situation in which imaging is performed exactly simultaneously using both image sensors 12.1, 12.2.

Lens arrangements F1, F2 with a set focal length are arranged in connection with the camera means 12, or more particularly with the camera elements CAM1, CAM2. The lens arrangements F1, F2 can be in connection with the sensors, for example, in a manner that is, as such, known. The focal lengths of the sets of lenses F1, F2, i.e. more specifically their zooming factors, are arranged so that they differ from each other in a set manner. The focal-length factor of at least one of the lens arrangements F1 can be fixed. This permits imaging data to be formed from the imaging subject 17 using different enlargement croppings, i.e. zoom settings.

According to a first embodiment, the focal-length factor of the first lens arrangement F1 in connection with the first camera element 12.1 can be, for example, in the range (0,1) 0,5-5, preferably 1-3, for example 1. Correspondingly, the focal-length factor of the second lens arrangement F2 in connection with the second camera element 12.2 differs in a set manner from the focal length of the first lens arrangement F1, i.e. from its zooming factor. According to one embodiment, it can be, for example, in the range 1-10, preferably 3-6, for example 3.

On the basis of the above, the enlargement of the image information IMAGE2 formed from the imaging subject 17 by the second camera element 12.2 is roughly three times that of the image information IMAGE1 formed by the first camera element 12.1 (shown schematically in FIG. 3).

However, the resolutions of both sensors 12.1, 12.2 and thus also of the image information IMAGE1, IMAGE2 formed by them both can and should be equally large. This means that in the image information IMAGE2 formed by the second camera element 12.2 there is only ⅓ of the imaging subject 17 exposed to the sensor 12.2, their resolution is nevertheless essentially roughly the same.

In the device 10 according to the invention, image information IMAGE with the desired amount of zoom is processed from the image data DATA1, DATA2 formed from the imaging subject 17 by the first and second camera elements CAM1, CAM2. The processing can be performed using the data-processing means 11 of the device 10, or even more particularly by the program 30 to be executed in the device 10.

Using the data-processing means 11, the sets of image data DATA1, DATA2 formed by the two camera elements 12.1, 12.2 with different focal lengths can be combined as image information IMAGE of the desired cropping and enlargement. In that case, the program code according to the invention includes a first code means 30.1, which is configured to combine these two sets of image data DATA1, DATA2 with each other in a set manner. In this case, the combination of the sets of image data DATA1, DATA2 can be understood very widely.

According to a first embodiment, the data-processing means 11 can adapt the image data DATA1, DATA2 formed by both camera elements 12.1, 12.2 to converge on top of each other to the desired zooming factor. In that case, the program code in the program product 30 includes a code means 30.1″, which is configured to combine the pixel information included in the image data DATA1, DATA″, into image information IMAGE with the desired cropping.

The pixel information included in the image data DATA1, DATA2 are then combined with each other as image information IMAGE with the desired cropping and enlargement. Due to the focal-length factors that differ from each other, part of the image information can consist of only the image data formed by one camera element CAM1 and part can consist of image data formed by both camera elements CAM1, CAM2. This image data DATA1, DATA2 formed by both camera elements CAM1, CAM2 is combined by program means with each other in the device 10.

According to a second embodiment, the data-processing means 11 can adapt to each other the sets of image data DATA1, DATA2 formed by both camera elements CAM1, CAM2 as a cut-like manner. Image regions defined by the image data DATA1, DATA2 are then attached to each other by the code means 30.1′ of the program product to form image information IMAGE of the desired trimming and enlargement.

Now, depending on the current zooming situation, part of the image information IMAGE can consist of only the image data DATA1 formed by the first camera element CAM1. This is because this part of the image information is not even available from the image data DATA2 of the second camera element CAM2, as its exposure area does not cover the image area detected by the first camera element CAM1, due to the focal-length factor set for it. The final part of the image data required to form the image information IMAGE is obtained from the image data DATA2 formed by the second camera element CAM2. Thus, the image data DATA1, DATA2 formed by both camera elements CAM1, CAM2 need not be combined with each other by “sprinkling” them onto the same image location, instead it is a question of, in a certain way, for example, a procedure resembling assembling a jigsaw puzzle.

Further, according to one embodiment, the data-processing means 11 can also perform set processing operations, in order to smoothly combine the sets of image data DATA1, DATA2 with each other. In that case, the program product 30 also includes, as program code, a code means 30.3, which is configured to process at least one of the sets of image data DATA2, in order to enhance it. The operations can be carried out on at least the second set of image data DATA2. Further, the operations can be directed to at least part of the data in the set of image data DATA2, which defines part of the image information IMAGE to be formed.

A few examples of the operations, which can be performed, include various fading operations. Further, operations adapting to each other and adjusting the brightness and/or hues of the image data DATA1, DATA2 to each other are also possible, without, of course excluding other processing operations. Hue/brightness adjustments may be required, for example, in situations in which the quality of the camera elements 12.1, 12.2 or of the sets of lenses F1, F2 differ from each other, thus interfering with the smooth combining of the sets of image data DATA1, DATA2.

Further, various distortion corrections are also possible. Examples of distortions include distortions of geometry and perspective. One example of these is the removal of the so-called fisheye effect appearing, for example, in panorama lenses. Distortion removal can be performed on at least one image IMAGE2 and further on at least a part of its image area.

The following is a description of the method according to the invention, with reference to the flow diagram of FIG. 2 as one individual example of an application. Reference is also made to FIG. 3, which shows the formation of image information IMAGE in the device 10 from the sets of image data DATA1, DATA2, according to the method of the invention. It should be noted that the real zooming ratios (1:3:2) of the images IMAGE1, IMAGE2, IMAGE shown in FIG. 3 are not necessarily to scale, but are only intended to illustrate the invention on a schematic level.

In order to perform imaging, the camera means 12 of the device are aimed at the imaging subject 17. In this example, the imaging subject is the mobile station 17 shown in FIG. 3.

Once the imaging subject 17 is in the exposure field of both camera elements 12.1, 12.2, the image data DATA1 produced from the imaging subject 17 by a single camera sensor 12.1 can be processed to form image information IMAGE1 to be shown on the viewfinder display/eyefinder 19 of the device 10. The user of the device 10 can direct, for example, the zooming operations that they wish to this image information IMAGE1, in order to define the cropping and enlargement (i.e. zooming) that they wish from the imaging subject 17 that they select. The operations can be selected, for example, through the user interface of the device 10, using the means/functionality 15.

Once the user has performed the zooming operations they desire, the images IMAGE1, IMAGE2 are captured using the camera means 12 of the device 10, in order to form image data DATA1, DATA2 from them of the imaging subject 17 (stage 201.1, 201.2).

Imaging is performed by simultaneously capturing the image using both camera elements CAM1, CAM2, which are equipped with lens arrangements F1, F2 that have focal lengths differing from each other in a set manner. Because the focal-length factor of the first lens arrangement F1 is, according to the embodiment, for example, 1, the imaging subject 17 is imaged by the image sensor 12.1 over a greater area, compared to the image-subject are imaged by the second image sensor 12.2.

If the focal-length factor of the second lens arrangement F2 is, for example, 3, a smaller area of the imaging subject 17, enlarged to the same image size, is captured by the image sensor 12.2. The definition of this smaller area is, however greater from the image area captured by the sensor 12.2, if it is compared, for example, to the image information IMAGE1 formed from the image data DATA1 captured using the sensor 12.1.

According to one embodiment, as the next stage 202.2 various selected image-processing operations can be performed on at least the second set of image data DATA2. In this case, the fisheye effect can be removed, for example. An example of the purpose of the operations is to adapt the sets of image data DATA1, DATA2 to each other, as inartefactially and seamlessly as possible and to remove other undesired features from them.

Some other examples of these image-processing operations are various fading operations and brightness and/or hue adjustment operations performed on at least one set of image data DATA2. Further, image-processing can also be performed on only part of their image areas, instead of on the entire image areas.

In the embodiment being described, final image information IMAGE is formed from the imaging subject 17, the zooming factor of which is between the fixed exemplary zooming factors (x1, x3) of the sets of lenses F1, F3. The example used is of the formation of image information IMAGE with a zooming factor of x2. In this case, the image information captured using the sensor 12.1 can be performed using region-select with the data-processing means 11 of the device 10. In it, an image region corresponding to the zooming factor 2 is cropped from the imaging subject 17 (stage 202.1). The cropping of an image region with the desired amount of zoom corresponds in principle to the digital zooming of the image IMAGE1. Thus, if, for example, the size of the original image IMAGE1 is 1280*960, then after applying cropping to the x2 embodiment, its size will be 640*480.

In stage 203.1, resizing to the image size is performed on the IMAGE1. The image size is then returned to its original size, i.e. now 1280×960. Because the image has now been enlarged using digital zooming, its definition will be slightly less than that of the corresponding original image IMAGE1, but nevertheless still at a quite acceptable level. After these operations, the image area covered by the image IMAGE1 can be imagined to be the area shown in the image IMAGE, which consists of the part of the mobile station 17 shown by both the broken line and the solid line.

After possible image-processing operations (stage 202.2) on the second image data DATA2, which can be understood as a ‘correcting image’ in a certain way, captured by the second camera element 12.2, operations are performed correspondingly to set its cropping and enlargement, in terms of the formation of image information IMAGE with the desired zooming. One example of these image-processing operations is the removal, or at least reduction of the fisheye effect. In this, various ‘pinch-algorithms’ can be applied. The basic principle in fisheye-effect removal is the formation of a rectangular presentation perspective.

The fisheye effect may be caused in the image information by factors such as the ‘poor quality’ of the sensor and/or the set of lenses, or the use of a sensor/lens arrangement that is a kind of panorama type. Distortion removal is carried out on an image IMAGE2 in its original size, so that the image information will be preserved as much as possible.

In the case according to the embodiment, the resolution of the second image IMAGE2 can also be reduced (i.e. throw away image information from it). One motivation for doing this is that in this way the image IMAGE2 is positioned better on top of the first image IMAGE1 (stage 203.2). Because the target image IMAGE has a zooming factor of the image x2, then according to this the reduction of the resolution is performed naturally also taking into account the image size of the target image IMAGE.

In the following stage 204.2 is performed the selection of the image region using the set region selection parameters (‘region select feather’ and ‘antialiasing’). The use of the feather and antialiasing properties achieves sharp, but to some extent faded edge areas, without ‘pixel-like blocking’ of the image. In addition, use of the antialiasing property also permits use of a certain amount of ‘intermediate pixel gradation’, which for its part softens the edge parts of the selected region. In this connection, application of various methods relating to the selection of image areas will be obvious to one versed in the art. For example, in the case of the embodiment, the height of the image IMAGE2 can be reduced by 5%, in which case the height will change from 960−>915 pixels. This is then a 45-pixel feather.

Next, in stage 205, the final image information IMAGE defined in the zooming stage of the imaging subject 17, is processed from the sets of image data DATA1, DATA2 formed using the first and second camera elements CAM1, CAM2.

In the processing, the sets of image data DATA1, DATA2 are combined with each other in a set manner.

The combination can be performed in several different ways. Firstly, the image regions IMAGE1, IMAGE2 defined from the sets of image data DATA1, DATA2 can be joined to each other by calculation, to obtain image information IMAGE with the desired zooming.

According to a second embodiment, the pixel information included in the sets of image data DATA1, DATA2 can be combined by calculation to form image information IMAGE with the desired zooming.

In the resulting image IMAGE shown in FIG. 3, joining of the sets of image data, or preferably of the image regions can, according to the first embodiment, be understood in such a way that the parts of the mobile station 17 in the edge areas of the image IMAGE, which are now drawn using solid lines, are from the set of image data DATA1 produced by the first camera element 12.1. The image regions in the centre of the image IMAGE, shown by broken lines, are then from the set of image data DATA2 produced by the camera element 12.2.

The definition of the image information of the edges of the output image IMAGE is now to some extent poorer, compared, for example, to the image information of the central parts of the image IMAGE. This is because, when forming the image information of the edge parts, the first image IMAGE1 had to be digitally zoomed slightly. On the other hand, the image region of the central part was slightly reduced, in which practically no definition of the image information IMAGE2 was lost.

When the pixel-data DATA1, DATA2 combination embodiment is examined, the situation is otherwise the same as above, except that now the parts of the mobile station 17 in the centre of the image IMAGE, i.e. those shown with broken lines, can include image data DATA1, DATA2 formed by both camera elements 12.1, 12.2. This only further improves the definition of the central part, because the sets of data DATA1, DATA2 of both sensors 12.1, 12.2 are now available for its formation. The combination embodiment can also be understood as a certain kind of layering of the images IMAGE1, IMAGE2.

It is possible to proceed according to similar basic principles, if it is desired to make larger zooming exceeding the fixed zooming factors of both lens arrangements F1, F2. The zooming would then be based on the image data DATA2 formed by the sensor 12.2 with the greater zoom, which would be digitally zoomed up to the set enlargement. The pixel data DATA1 from the first sensor 12.1, corresponding to the desired zooming, can then be suitably adapted (i.e. now by layering) to this enlargement. This will then permit zooming to larger factors than the fixed factors provided by the sets of lenses F1, F2, without unreasonably reducing definition. When using sets of lenses F1, F2 according to the embodiment, zooming with a factor of as much as 5−10(−15) may even be possible in question.

Because the sensors 12.1, 12.2 are aligned, for example, horizontally parallel to each other in a selected direction, there may be a slight difference in the horizontal direction of the exposure areas covered by them. Image recognition based on program, for example, can be applied to the subsequent need for re-alignment, when combining the image information IMAGE1, IMAGE2. For example, analogies known from hand scanners may be considered.

The invention also relates to a camera element CAM1. The camera element CAM1 includes at least one image sensor 12.1, by which image data DATA1 can be formed from the imaging subject 17. The camera element 12.1 can be arranged in the electronic device 10, or applied to the method, according to the invention, for forming image information IMAGE.

The invention can be applied in imaging devices, in which arranging of the optical zooming have been difficult or otherwise restricted, such as, for example, in camera telephones, or in portable multimedia devices. The invention can also be applied in panorama imaging. Application is also possible in the case of continuous imaging.

It must be understood that the above description and the related figures are only intended to illustrate the present invention. The invention is thus in no way restricted to only the embodiments disclosed or stated in the Claims, but many different variations and adaptations of the invention, which are possible within the scope on the inventive idea defined in the accompanying Claims, will be obvious to one versed in the art.

1. An electronic device A, which includes
camera means, including at least one camera element (CAM1) for forming image data (DATA1) from an imaging subject,
a first lens arrangement (F1) according to a set focal length, arranged in connection with the camera means, and
means m for processing the image data (DATA1) into image information (IMAGE), the processing including zooming of the imaging subject, and
the said camera means additionally include at least a second camera element (CAM2) equipped with a second lens arrangement (F2), the focal length of which differs from the focal length of the said first lens arrangement (F1) in an established manner, characterized in that from the sets of image data (DATA1, DATA2) formed simultaneously by the first and second camera elements (CAM1, CAM2) is arranged to be processed by using the data-processing means the image information (IMAGE) with the desired zooming of the imaging subject.

2. An electronic device according to claim 1, characterized in that the data-processing means are arranged to combine the image areas defined by the sets of image data (DATA1, DATA2), to form the image information (IMAGE) with the desired zooming.

3. An electronic device according to claim 1, characterized in that the data-processing means are arranged to combine the pixel information included in the sets of image data (DATA1, DATA2), to form image information (IMAGE) with the desired zooming.

4. An electronic device according to claims 1, characterized in that
the focal-length factor of the said first lens arrangement (F1) is, for example, 0,1 −3, preferably 1-3, such as, for example, 1 and
the focal-length factor of the said second lens arrangement (F2) is, for example, 1-10, preferably 2-5, such as, for example, 3.

5. An electronic device according to claim 1, characterized in that the focal-length factor of at least the second lens arrangement (F2) is fixed.

6. An electronic device according to claim 1, characterized in that the data-processing means are arranged to perform the set processing operations on at least the second set of image data (DATA2), such as, for example, adjusting the size, fading operations, and/or the adjustment of brightness and/or hue.

7. An electronic device according to claim 1, characterized in that the data-processing means are arranged to perform distortion correction on at least the second set of image data (DATA2).

8. A method for forming image information (IMAGE) from image data (DATA1, DATA2), in which method
camera means are used to perform imaging in order to form image data (DATA1) of the imaging subject, the camera means including at least one camera element (CAM1) equipped with a first lens arrangement (F1) with a set focal length (stage 201.1) and
the formed image data (DATA1) is processed in order to zoom the imaging subject (stages 202.1, 203.1),
characterized in that simultaneous imaging with the camera element (CAM1) equipped with a first lens arrangement (F1) is performed in addition using at least a second camera element (CAM2), the focal length of the lens arrangement (F2) in connection with which differs in a set manner from the focal length of the said first lens arrangement (F1) (stage 201.1) and image information (IMAGE) with the desired zooming is processed from the sets of image data (DATA1, DATA2) formed simultaneously by using the first and second camera elements (CAM1, CAM2) (stage 205).

9. A method according to claim 8, characterized in that the sets of image data (DATA1, DATA2) are combined with each other (stage 205).

10. A method according to claim 8, characterized in that the image areas defined by the sets of image data (DATA1, DATA2) are combined to each other, to form image information (IMAGE) with the desired zooming.

11. A method according to claim 8, characterized in that the pixel information included in the sets of image data (DATA1, DATA2) is combined to form image information (IMAGE) with the desired zooming.

12. A method according to claim 8, characterized in that the imaging is performed through lens arrangements (F1, F2), the focal-length factor of one of which lens arrangements (F1) is, for example, 0,1-5, preferably 1-3, such as, for example 1, and the focal-length factor of the other of which lens arrangements (F2) is, for example, 1-10, preferably 2-5, such as, for example 3.

13. A method according to claim 8, characterized in that fading operations are performed on at least the second set of image data (DATA2) (stage 205).

14. A method according to claim 8, characterized in that brightness and/or hue adjustment is performed on at least the second set of image data (DATA2) (stage 205).

15. A method according to claim 8, characterized in that distortion correction is performed on at least the second set of image data (DATA2) (stage 202.2).

16. A program product for processing image data (DATA1, DATA2), which product includes a storage medium (MEM, 11) and program code written on the storage medium (MEM, 11) for processing image data (DATA1, DATA2) produced by using at least one camera element (CAM1), and in which the image data (DATA1, DATA2) is arranged to be processed to form image information (IMAGE), the processing including of the zooming of the imaging subject, characterized in that the program code includes a first code means configured to combine in a set manner two sets of image data (DATA1, DATA2) with each other, which sets of image data (DATA1, DATA2) are formed simultaneously by using two camera elements (CAM1, CAM2) with different focal lengths.

17. A program product according to claim 16, characterized in that the program code includes code means configured to combine the image areas defined by the sets of image data (DATA1, DATA2) to form image information (IMAGE) with the desired zooming.

18. A program product according to claim 16, characterized in that the program code includes code means configured to combine the pixel information included in the sets of image data (DATA1, DATA2) to form image information (IMAGE) with the desired zooming.

19. A program product according to claim 16, characterized in that the program product ( includes additionally a second code means configured to process at least the second set of image data (DATA2), in order to enhance it in at least part of its image area, the processing including of, for example, fading and/or adjusting brightness and/or hue.

20. A program product according to claim 16, characterized in that the program product includes additionally a third code means configured to process at least the second set of image data (DATA2) in order to correct distortions.

21. A camera element (CAM1), including at least one image sensor, by means of which image data (DATA1) is arranged to be formed from the imaging subject, characterized in that the camera element (CAM1) is arranged to be used in the electronic device according to claim 1.

22. A camera element (CAM1), including at least one image sensor, by means of which image data (DATA1) is arranged to be formed from the imaging subject, characterized in that the camera element (CAM1) is arranged to be used in a sub-stage of the method according to claim 8.
